(19) United States
(12) Patent Application Publication
(10) Pub. No.: US 2002/0130788 A1
(43) Pub. Date: Sep. 19, 2002

(54) Remote controlled door lock system

(76) Inventor: Apin Chang, Chung-Ho City (TW)

Correspondence Address: TROP PRUNER & HU, PC, 8554 KATY FREEWAY, SUITE 100, HOUSTON, TX, 77024, US

(21) Appl. No.: 09/837,016

(22) Filed: Apr. 18, 2001

(30) Foreign Application Priority Data
Mar. 14, 2001 (TW) 090203797

(51) Int. Cl. H04Q 1/00

(52) U.S. Cl. 340/825.72; 340/5.33

(57) ABSTRACT

In a remote controlled door lock system, a door lock apparatus transmits a confirm signal wirelessly upon controlling a door lock device thereof to operate in a selected one of the armed and disarmed states. A remote controller has a receiver circuit for receiving the confirm signal transmitted by the door lock apparatus, and an indicator unit for generating an indicator signal when the remote controller receives the confirm signal from the door lock apparatus.

### BACKGROUND OF THE INVENTION

1. Field of the Invention

The invention relates to a door lock system for automobiles, more particularly to a remote controlled centralized door lock system which permits real-time confirmation of an armed or disarmed state of a door lock device in an energy-efficient manner.

2. Description of the Related Art

Remote controlled centralized door lock systems for automobiles are known in the art. Such conventional door lock systems generally include a door lock device and a handheld remote controller for generating an arming control signal to operate the door lock device in an armed state, where the door lock device locks the doors of an automobile, and for generating a disarming control signal to operate the door lock device in a disarmed state, where the door lock device unlocks the doors of the automobile. In order to allow the user to confirm whether the door lock device is in the armed or disarmed state at a distance from the automobile, the conventional door lock system activates cabin lights of the automobile for a short amount of time in response to the arming or disarming control signal generated by the remote controller. The arrangement as such is advantageous only under poor surrounding light conditions, such as at night.

### SUMMARY OF THE INVENTION

Therefore, the main object of the present invention is to provide a remote controlled door lock system which permits real-time confirmation of an armed or disarmed state of a door lock device in an energy-efficient manner.

According to the present invention, a remote controlled door lock system comprises a remote controller and a door lock apparatus.

The remote controller includes a controller circuit and a first transmitter circuit coupled electrically to and controlled by the controller circuit so as to transmit a control signal wirelessly.

The door lock apparatus includes a first receiver circuit for receiving the control signal transmitted by the first transmitter circuit, a lock control circuit coupled electrically to the first receiver circuit so as to receive the control signal therefrom, a door lock device coupled electrically to and controlled by the lock control circuit to operate in a selected one of armed and disarmed states in response to the control signal from the first receiver circuit, and a second transmitter circuit coupled electrically to and controlled by the lock control circuit to transmit a confirm signal wirelessly upon controlling the door lock device to operate in the selected one of the armed and disarmed states.

The remote controller further includes a second receiver circuit and an indicator unit. The second receiver circuit receives the confirm signal transmitted by the second transmitter circuit. The controller circuit is coupled electrically to the second receiver circuit so as to receive the confirm signal therefrom. The indicator unit is coupled electrically to and is controlled by the controller circuit to generate an indicator signal in response to the confirm signal from the second receiver circuit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a handheld remote controller of the preferred embodiment of a remote controlled door lock system according to the present invention; and

FIG. 2 is a schematic circuit block diagram illustrating a door lock apparatus of the preferred embodiment.

### DETAILED DESCRIPTION OF THE PREFERRED EMBODIMENT

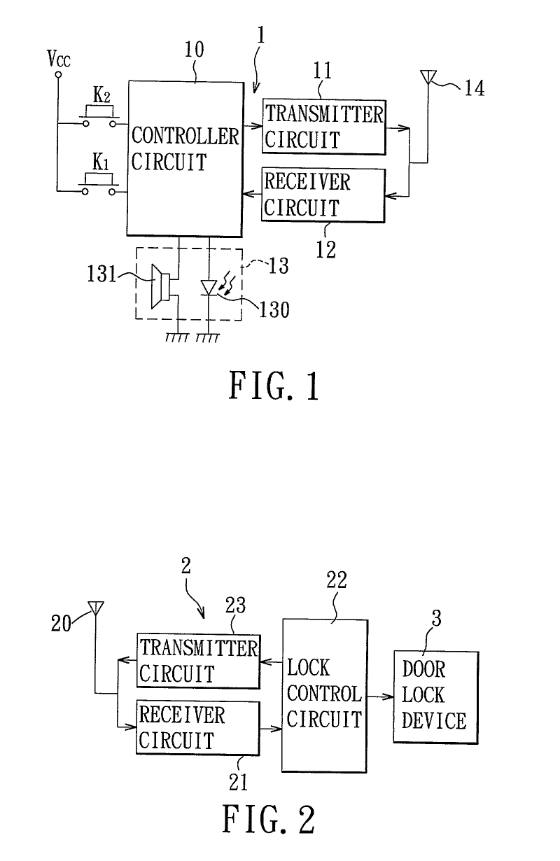

Referring to FIGS. 1 and 2, the preferred embodiment of a remote controlled centralized door lock system according to the present invention is shown to comprise a handheld remote controller 1 and a door lock apparatus 2.

The remote controller 1 includes an arming control button (K1), a disarming control button (K2), a controller circuit 10, a transmitter circuit 11, a receiver circuit 12, an indicator unit 13, and an antenna 14. The remote controller 1 further includes batteries (not shown) for supplying electric power thereto. The controller circuit 10 is coupled electrically to the arming and disarming control buttons (K1, K2). The transmitter circuit 11 is coupled electrically to the controller circuit 10 and the antenna 14. The transmitter circuit 11 is controlled by the controller circuit 10 so as to transmit an arming control signal wirelessly via the antenna 14 when the arming control button (K1) is operated, and so as to transmit a disarming control signal wirelessly via the antenna 14 when the disarming control button (K2) is operated.

The door lock apparatus 2 is adapted to be installed in an automobile (not shown), and includes an antenna 20, a receiver circuit 21, a lock control circuit 22, a door lock device 3, and a transmitter circuit 23. Electric power to the door lock apparatus 2 is supplied by the automobile in a known manner. The receiver circuit 21 is coupled electrically to the antenna 20, and receives the control signal, i.e. the arming or disarming control signal, transmitted by the transmitter circuit 11 of the remote controller 1 via the antenna 20. The lock control circuit 22 is coupled electrically to the receiver circuit 21 so as to receive the arming or disarming control signal therefrom. The door lock device 3 is coupled electrically to and is controlled by the lock control circuit 22 to operate in a selected one of an armed state, where the door lock device 3 locks the doors of the automobile in a known manner in response to the arming control signal received by the lock control circuit 22 from the receiver circuit 21, and a disarmed state, where the door lock device 3 unlocks the doors of the automobile in a known manner in response to the disarming control signal received by the lock control circuit 22 from the receiver circuit 21. The transmitter circuit 23 is coupled electrically to the lock control circuit 22 and the antenna 20. The transmitter circuit 23 is controlled by the lock control circuit 22 to transmit a confirm signal wirelessly via the antenna 20 upon controlling the door lock device 3 to operate in the selected one of the armed and disarmed states

The receiver circuit 12 of the remote controller 1 is coupled electrically to the antenna 14 and the controller circuit 10. The receiver circuit 12 receives the confirm signal transmitted by the transmitter circuit 23 of the door lock apparatus 2 via the antenna 14. The controller circuit 10 receives the confirm signal from the receiver circuit 12. The indicator unit 13 is coupled electrically to and is controlled by the controller circuit 10 so as to generate an indicator signal in response to the confirm signal received by the controller circuit 10 from the receiver circuit 12. In this embodiment, the indicator unit 13 includes a lamp indicator 130, such as a light emitting diode, and a sound generating unit 131, such as a buzzer.

In view of the aforesaid construction of the remote controlled centralized door lock system of the present invention, by virtue of the indicator unit 13 on the remote controller 1, the user is able to confirm in real-time whether the door lock device 3 is in the armed or disarmed state at a distance from the automobile regardless of the surrounding light conditions. In addition, because the confirm signal is transmitted only upon controlling the door lock device 3 to operate in the selected one of the armed and disarmed states, there is no need to configure the remote controller 1 to be always on stand-by, thereby minimizing energy consumption of the same.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A remote controlled door lock system, comprising:
a remote controller including a controller circuit and a first transmitter circuit coupled electrically to and controlled by said controller circuit so as to transmit a control signal wirelessly; and
a door lock apparatus including a first receiver circuit for receiving the control signal transmitted by said first transmitter circuit, a lock control circuit coupled electrically to said first receiver circuit so as to receive the control signal therefrom, a door lock device coupled electrically to and controlled by said lock control circuit to operate in a selected one of armed and disarmed states in response to the control signal from said first receiver circuit, and a second transmitter circuit coupled electrically to and controlled by said lock control circuit to transmit a confirm signal wirelessly upon controlling said door lock device to operate in the selected one of the armed and disarmed states;
said remote controller further including a second receiver circuit for receiving the confirm signal transmitted by said second transmitter circuit, said controller circuit being coupled electrically to said second receiver circuit so as to receive the confirm signal therefrom;
said remote controller further including an indicator unit coupled electrically to and controlled by said controller circuit to generate an indicator signal in response to the confirm signal from said second receiver circuit.

2. The remote controlled door lock system of claim 1, wherein said indicator unit includes a lamp indicator.

3. The remote controlled door lock system of claim 2, wherein said lamp indicator is a light emitting diode.

4. The remote controlled door lock system of claim 1, wherein said indicator unit includes a sound generating unit.

5. The remote controlled door lock system of claim 4, wherein said sound generating unit is a buzzer.
